(19) United States
(12) Patent Application Publication
(10) Pub. No.: US 2016/0271790 A1
(43) Pub. Date: Sep. 22, 2016

(54) SYSTEM FOR RELATIVE MOVEMENT BETWEEN TWO PLATES AND POSITIONING DEVICE COMPRISING SUCH A MOVEMENT SYSTEM

(71) Applicants: Bertrand de Saint Leve d'Aguerre, Chatignonville (FR); Alain Jeanne, Amilly (FR)

(72) Inventors: Bertrand de Saint Leve d'Aguerre, Chatignonville (FR); Alain Jeanne, Amilly (FR)

(73) Assignee: MICRO-CONTROLE SPECTRA-PHYSICS, Evry (FR)

(21) Appl. No.: 15/071,582

(22) Filed: Mar. 16, 2016

(30) Foreign Application Priority Data
Mar. 16, 2015 (FR) 1552150

(51) Int. Cl. B25J 7/00

(52) U.S. Cl. CPC B25J 7/00

(57) ABSTRACT

A system provides for relative movement between two plates that are substantially parallel to a plane defined by a first direction and a second direction. The system includes a first unit that is configured to allow a relative movement between the two plates in a third direction that is orthogonal to the plane. The first unit also independently prevents a relative movement between the two plates in the plane. The system further includes a second unit that is configured to allow one plate to relatively travel with respect to the other plate about the first and second directions.

### BACKGROUND

The present disclosure relates to a system for relative movement between two plates and to a positioning device comprising such a movement system.

More particularly, though not exclusively, the present disclosure applies to a precise positioning device (or machine) for the semiconductor and electronics industry, in particular for the etching of printed circuits or semiconductors.

The purpose of this system is to allow relative movement between two generally planar plates which are substantially parallel to each other, relative to a given plane. This relative movement generally relates to a “vertical” movement, that is to say, orthogonal to said plane, which is associated with stiffness in said plane.

The decoupling means are generally complex and relatively bulky.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present disclosure relates to a movement system of this type that makes it possible to overcome these drawbacks and, in particular, to enable advantageous optimization of various parameters according to the intended application.

To this end, according to the disclosure, said system for relative movement between two planar plates that are substantially parallel to an XY plane defined by a direction referred to as the X direction and a direction referred to as the Y direction is remarkable in that it comprises a first unit that is configured to allow a relative movement between the two plates in a Z direction, which is orthogonal to the XY plane, and to independently prevent a relative movement between the two plates in the XY plane, and a second unit that is configured to allow one plate to relatively travel with respect to the other plate about the X and Y directions.

Thus, by virtue of the disclosed system, stiffness is generated in the XY plane that is independent of the position in Z, which allows long travel distances in Z. Independence of the functions is provided, which enables optimization of various parameters according to the application in question (mass of the system, size, amplitude of the rotations and of the translation, required stiffness, etc.).

The presently disclosed system is more particularly suitable for microelectronics.

In the context of the present disclosure, the first and second units may be produced in various ways. In particular, said first unit may advantageously comprise one of the following assemblies:
an assembly comprising at least one ball bushing having one or two degrees of freedom;
an assembly comprising at least one air socket;
a set of guide rings; and
a set of rails having balls or rollers.

Furthermore, said second unit advantageously comprises one of the following assemblies:
a decoupling blade;
a mechanical decoupling part;
a mechanical universal joint.

Moreover, in a first variant, the movement system comprises a third unit that is configured to prevent the plates from moving about the Z direction. Advantageously, said third unit comprises one of the following assemblies:
a link;
a guiding assembly.

Furthermore, in a second variant, the movement system comprises a fourth unit that is configured to allow movement about the Z direction. Advantageously, the fourth unit comprises one of the following assemblies:
an actuator integrated in a link;
at least one tangential linear motor.

Moreover, in a particular embodiment:
the first unit comprises a support fixed to one of said plates, the support being provided with a cylindrical internal recess, of which the axis is parallel to the Z direction and inside which ball bushings are mounted coaxially, the other one of said plates being connected to one end of a solid cylinder that passes through the ball bushings; and/or
the second unit comprises a decoupling-blade assembly comprising an external annular structure that is fixed to one of said plates, the decoupling-blade assembly comprising a disc that is provided with a plurality of flexible blades, fixed centrally with respect to the other one of said plates.

The present disclosure also relates to a positioning device that comprises a movement system as described above.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

The accompanying figures will give a clear understanding as to how the disclosed system can be implemented. In these figures, identical references designate similar elements.

FIG. 1 is a perspective view of a particular embodiment of a movement system.

FIG. 2 is a partial view, in perspective and in cross section, of a movement system of FIG. 1.

FIG. 3 is an exploded perspective view of the movement system of FIG. 1.

FIG. 4 is a view similar to that of FIG. 1, without a lower plate.

FIG. 5 is an exploded perspective view of the elements of the movement system of FIG. 4.

### DETAILED DESCRIPTION

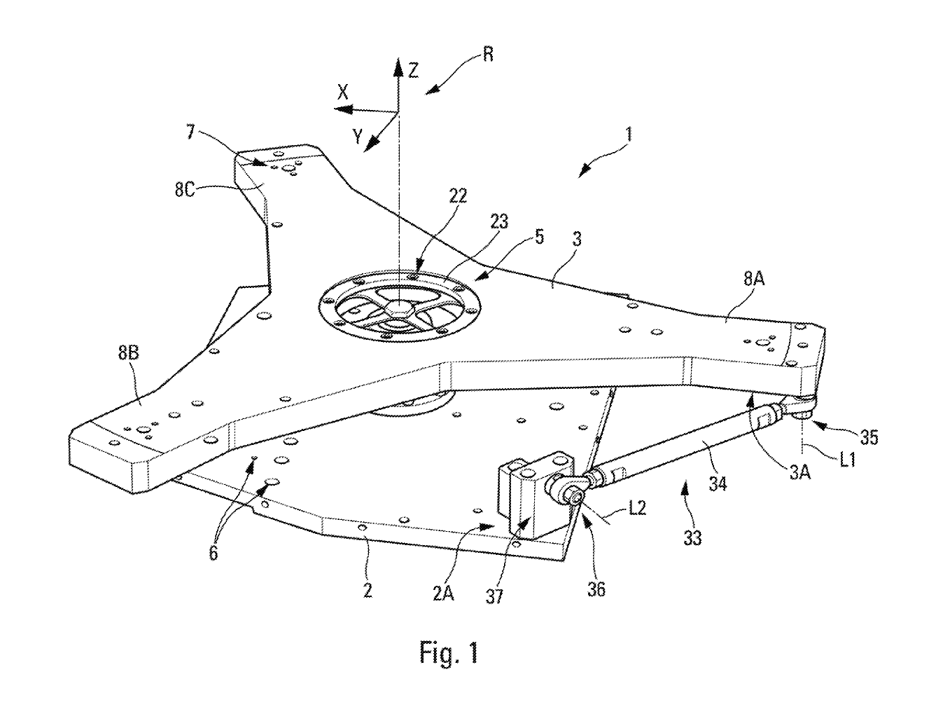

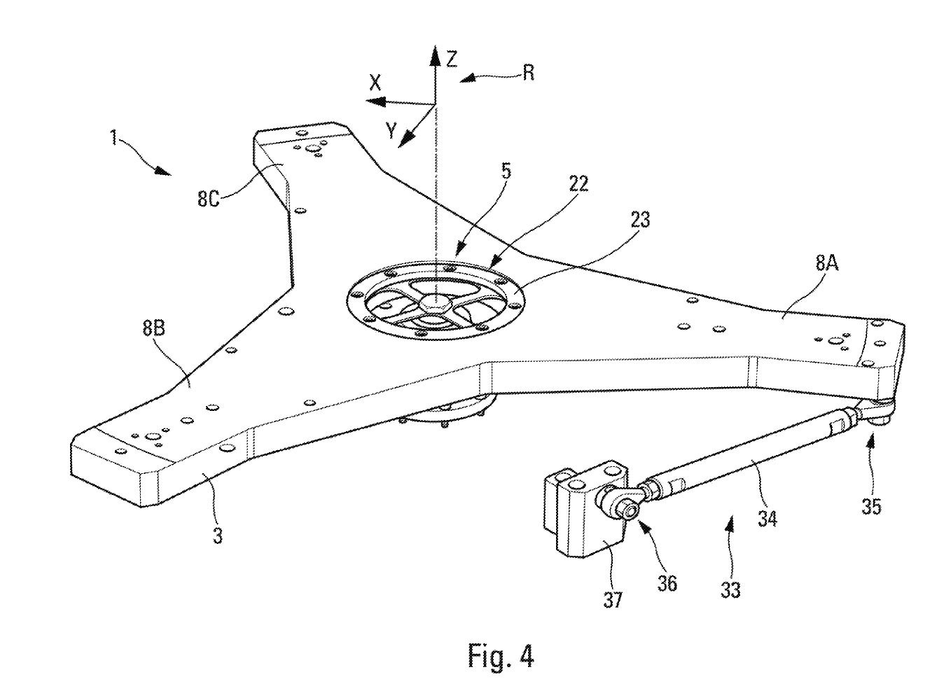

The system 1 (hereinafter referred to as “movement system 1”) that is depicted in FIGS. 1 to 5 for illustrating the invention is a system for generating a relative movement between two generally planar plates 2 and 3.

These two plates 2 and 3 are arranged substantially in parallel with an XY plane that is defined by a direction referred to as the n X direction and a direction referred to as the Y direction. When the two plates 2 and 3 are in a neutral position, they are both completely parallel to the XY plane.

These X and Y directions form part of a frame of reference R (or XYZ) that is depicted in FIGS. 1 to 5. This frame of reference R, intended to facilitate understanding, comprises, in addition to the X and Y directions (or axes) forming the XY plane, a Z direction (or axis) that is orthogonal to said XY plane.

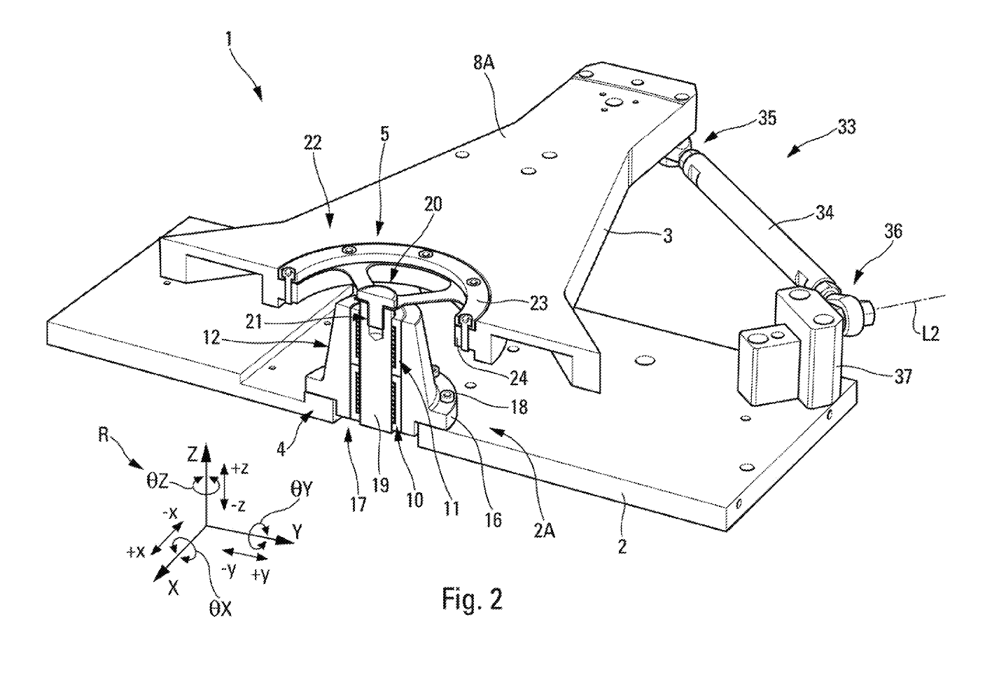

FIG. 2 shows a detailed frame of reference R, comprising:
for the X direction, a positive direction (shown by an arrow +x) and a negative direction (shown by an arrow −x);
for the Y direction, a positive direction (shown by an arrow +y) and a negative direction (shown by an arrow −y);
for the Z direction, a positive direction (shown by an arrow +z) and a negative direction (shown by an arrow −z); and
angles θX, θY and θZ (shown by double arrows) which illustrate rotations about the X, Y and Z axes, respectively.

For reasons of clarity, the frame of reference R detailed in FIG. 2 is shown outside the movement system 1. However, the Z direction passes through a central vertical axis, as shown in FIGS. 1 and 3 to 5.

The adjectives “upper” and “lower” in the following description apply with respect to the direction defined by the arrow of the Z direction, “upper” being in the direction (+z) of the arrow and “lower” being in the opposite direction (−z).

The plate 2 that is arranged under the plate 3, in the direction thus defined, is referred to as “the lower plate”, and the plate 3 is referred to as “the upper plate”. The lower plate 2 may be fixed to a support element (not shown) by means of fixing means, for example screws that pass through holes 6 that are visible in the plate 2 (FIG. 1).

As for the plate 3, this can support particular elements, which may be fixed thereto, by means of fixing means, for example screws that pass through holes 7 that are visible in the plate 3 (FIG. 1).

The plate 3 comprises three similar plate portions 8A, 8B and 8C that are generally radial and have a general shape that narrows outwards (radially with respect to the Z axis). These three plate portions 8A, 8B and 8C are connected together so as to be uniformly distributed about the Z direction.

In a preferred application, the movement system 1 that comprises these two plates 2 and 3 forms part of a precise positioning device (or machine) for the semiconductor and electronics industry, in particular for the etching of printed circuits or semiconductors.

According to the invention, said movement system 1 comprises:
a unit 4 that is configured to allow a relative movement between the plate 2 and the plate 3 in the Z direction (which is therefore orthogonal to the XY plane) and to prevent a relative movement between the two plates 2 and 3 in the XY plane; and
a unit 5 that is configured to allow one plate 3 to relatively travel with respect to the other plate 2, about X and Y directions, as illustrated by angles θX and θY in FIG. 2.

“Relative movement” is understood to mean a movement of one of said plates 2 and 3 with respect to the other.

The unit 5 may produce as required:
a relative movement about the X direction only (θX);
a relative movement about the Y direction only (θY); or
a relative movement simultaneously about the two X and Y directions (θX and θY).

The units 4 and 5 may be produced in various ways, as described below.

Thus, by means of the units 4 and 5, stiffness is generated in the XY plane that is independent of the position of the plate 3 in Z with respect to the plate 2, that is to say the relative position between the two plates 2 and 3, which allows long travel distances in Z.

In the movement system 1, independence of functions is provided, which enables optimisation of the various parameters according to the intended application (mass of the system, size, amplitude of the rotations and of the translation in Z, required stiffness, etc.).

The present invention is particularly suitable for microelectronics. This is because the equipment for positioning components, including plates or semiconductors (wafers), under lenses, requires the following mechanical features: stiffness in the X and Y axes to guarantee short stabilisation times during highly dynamic movements, movements in Z for adapting focal distances, and adjustment of the angular position of the plane of the object having the focal plane.

As shown in FIG. 1, the two generally planar plates 2 and 3 are therefore mounted substantially parallel with respect to each other and with respect to the XY plane. The unit 4 allows a movement (translation) of the plate 3 with respect to the plate 2 in the vertical Z direction. This unit 4 also prevents a movement (translation) of the plate 3 with respect to the plate 2 in the X direction and/or in the Y direction.

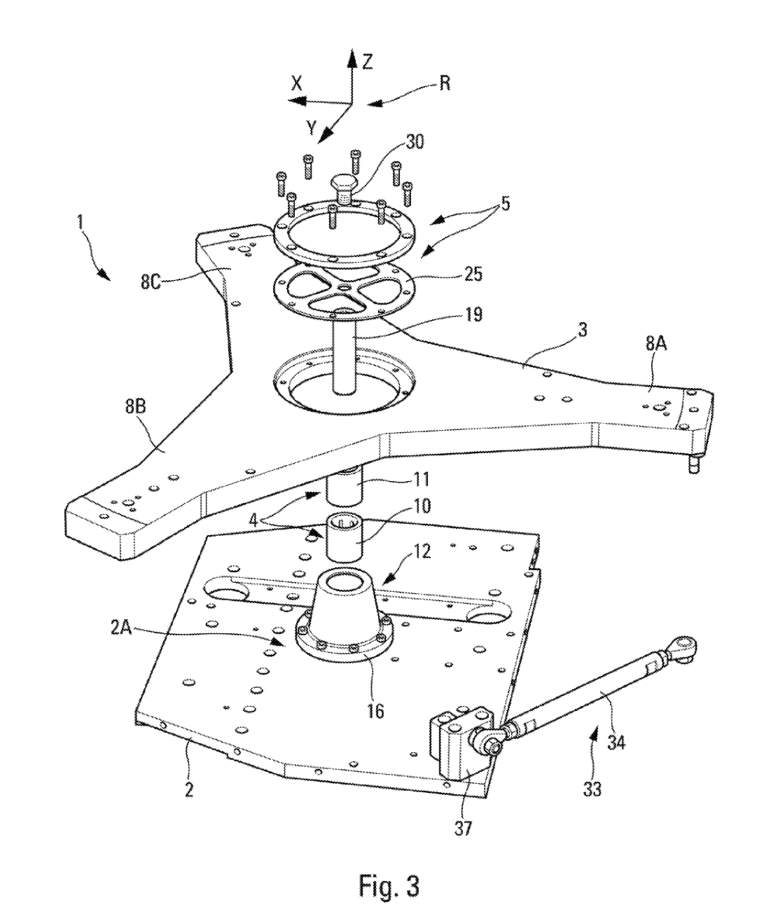

For this purpose, in the example depicted, the unit 4 comprises two ball bushings 10 and 11 that enter a support 12 mounted so as to project with respect to the plate 2, as can be seen in particular in FIGS. 2 and 3.

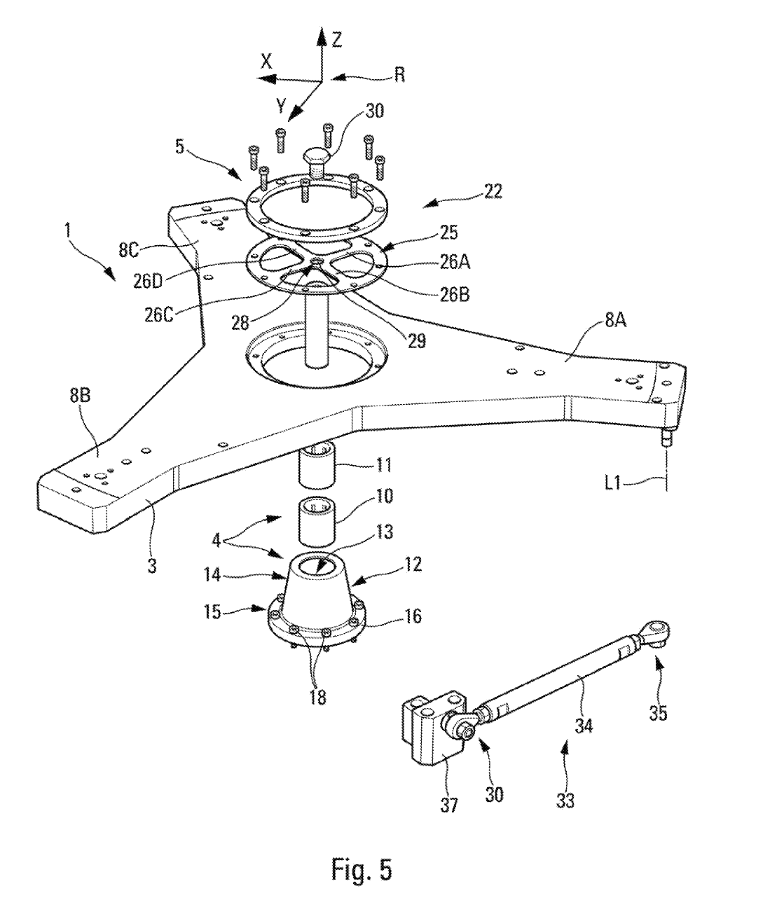

This support 12 has an elongate shape having a cylindrical internal recess 13, of which the axis is parallel to the Z direction, and a conical external contour 14 that broadens towards the lower end 15 and comprises an annular rim 16 provided at its lower end 15 (FIG. 5). The support 12 enters, by its lower end, a circular opening 17 formed in the plate 3 and is fixed, for example by means of screws 18, via the annular rim 16, to the plate 2, the annular rim 16 resting on the upper face 2A of the plate 2 (FIG. 2).

The two similar ball bushings 11 and 12 are mounted coaxially inside the cylindrical recess 13, one above the other in the Z direction.

The plate 3 is connected to an upper end of a solid cylinder 19 (FIG. 2) that passes through the ball bushings 10 and 11, via a retaining assembly 20.

The solid cylinder 19 can slide in the Z direction. Given that the solid cylinder 19 is rigidly secured to the plate 3 and the support 12 is rigidly secured to the plate 2, this sliding represents vertical guidance in the Z direction between the plate 3 and the plate 2. In addition, a relative movement is prevented in the XY plane.

Furthermore, in the example depicted in the figures, the unit 5 comprises a decoupling-blade assembly 22. This decoupling-blade assembly comprises an external annular structure 23 that is fixed to a rim 24 of the plate 3 (FIG. 2). This rim 24 of the plate 3 is formed in the internal contour of a circular opening formed in the plate 3.

The decoupling-blade assembly 22 comprises a disc 25 provided for example with four blades 26A, 26B, 26C, 26D that are uniformly distributed about the Z axis and join one other in a central portion 28 (FIG. 5). This central portion 28 is provided with an opening 29 for receiving a screw 30 (of the retaining assembly 20) intended to enter a threaded cylindrical recess in the solid cylinder 19. The number and thickness of the blades are defined according to the desired stiffness XY and the amplitude about X and Y necessary for the intended application.

Owing to the blades 26A to 26D, the decoupling-blade assembly 22 has a certain flexibility. This flexibility allows a slight movement of the plate 3 with respect to the plate 2, about X and Y axes, as illustrated by the angles θX and θY on the frame of reference R (FIG. 2).

The unit 4 may be produced in various ways, including the preferred way depicted in the figures. By way of illustration, said first unit 4 may comprise:
a set of ball bushing(s) having one or two degrees of freedom (allowing a rotation and a translation), like the set comprising the ball bushings 10 and 11 (FIG. 2);
a set of air socket(s) (using aerostatic guidance without friction);
a set of guide rings (for example made from bronze and having an antifriction coating); and
a set of rails having balls or rollers. Where a rotation about the Z axis is provided, as described below, the latter set may comprise a bearing.

The unit 5 may also be produced in various ways, including the preferred way depicted in the figures. By way of illustration, said unit 5 may comprise one of the following assemblies:
a decoupling blade of the single-layered or multi-layered type;
a mechanical decoupling part (produced by wire cutting or by normal machining);
a mechanical universal joint (having a spider and bearings, or an assembly of rings and hinges, etc.).

Moreover, in a first particular embodiment, the movement system 1 comprises a unit 33 that is configured to prevent a relative movement of the plates 2 and 3 with respect to each other about the Z direction.

In the example depicted in FIGS. 1 to 5, the unit 33 comprises a link 34 that is connected, in a hinged manner, by a first end 35, to the lower surface 3A (FIG. 1) of a plate portion 8A of the plate 3 in the region of its radially external end.

The end 35 of the link is hinged to the plate 3 so as to able to rotate about an axis L1 parallel to the Z direction (FIGS. 1 and 5).

In addition, the link 34 is hingedly connected by its other end 36 to a support block 37 fixed to the upper face 2A of the plate 2.

The end 36 of the link 34 is hinged to the plate 2 so as to be able to rotate about an axis L2 parallel to the XY plane (FIGS. 1 and 2). The axis L2 may correspond to the bisector of the angle formed by the direction −x and +y of the X and Y directions.

The link 34 may further comprise clearance-takeup springs.

Owing to the hinges provided, the link 34 does not prevent relative movement in Z and movements on θX and θY, but locks against rotation about the Z axis (of the plate 3 with respect to the plate 2).

The three functions of vertical guidance (along the Z axis), of rotational guidance about the X and Y axes and of locking against rotation about the Z axis are carried out by three independent units 4, 5 and 33, respectively. According to the application in question, the independence of these functions enables optimisation of various parameters, such as the mass of the system, the size, the amplitude of the rotations and of the translation, the required stiffness, etc.

The unit 33 may be produced in various ways. By way of illustration, said unit 33 may comprise one of the following assemblies:
a link, such as the link 34;
a guiding assembly, for example having a roller on a vertical track.

Instead of comprising for example a very wide vertical decoupling plate, the movement system 1 comprises a central axis in Z and a small plate 3 that is flexible on θX and θY but stiff in XY and θZ.

Moreover, in a second particular embodiment, the movement system 1 comprises a unit (not shown) configured to allow a movement about the Z direction.

This unit may also be produced in various ways. By way of illustration, this unit comprises one of the following assemblies:
an actuator of the electric or piezoelectric type, which is integrated in a suitably shaped link. This link may be hinged to the plates 2 and 3 just like the link 34;
one or more tangential linear motors.

In this second embodiment, it is possible to control the rotation of the plate 3 with respect to the plate 2 about the Z axis by means of the aforementioned unit, which is controllable.

By way of illustration, the movement system 1 can be integrated in a positioning machine for decoupling the movements Z and OZ of a movement base XY for aligning semiconductor wafers, substrates or printed circuits, and for adjustment in Z for focusing or adaptation to semiconductor wafers, substrates or printed circuits of several thicknesses.

In a preferred application:
the plate 2 is produced from aluminium;
the plate 3 is produced from aluminium;
the plate 2 has thickness of 12 to 20 mm;
the plate 3 has a thickness of 20 to 25 mm;
the plate 3 fits in a circle having a radius of between 400 and 700 mm.

In addition, in a preferred application, the movement system 1 allows:
a movement in the Z direction of a length of between 4 and 10 mm;
a rotation about the X direction by an angle of between 1° and 2°;
a rotation about the Y direction by an angle of between 1° and 2°; and
in the second embodiment, a rotation about the Z direction by an angle of between 1° and 5°.

While illustrative embodiments have been illustrated and described, it will be appreciated that various changes can be made therein without departing from the spirit and scope of the invention.

The embodiments of the invention in which an exclusive property or privilege is claimed are defined as follows:

1. A system for relative movement between two plates that are substantially parallel to a plane defined by a first direction and a second direction perpendicular to the first direction, the system comprising:
a first unit configured to allow a relative movement between the two plates in a third direction, the third direction being orthogonal to the plane; and
a second unit configured to allow one plate to relatively travel with respect to the other plate about first and second directions,
wherein the first unit is configured to independently prevent a relative movement between the two plates in the plane.

2. The system of claim 1, wherein the first unit comprises one of (a) an assembly comprising at least two ball bushings having one or two degrees of freedom; (b) an assembly comprising at least one air socket; (c) a set of guide rings; and (d) a set of rails having balls or rollers.

3. The system of claim 1, wherein the second unit comprises one of (a) a decoupling blade; (b) a mechanical decoupling part; and (c) a mechanical universal joint.

4. The system of claim 1, wherein the system comprises a third unit that is configured to prevent a movement of the plates about the third direction.

5. The system of claim 4, wherein the third unit comprises one of (a) a link and (b) a guiding assembly.

6. The system of claim 1, wherein the system comprises a fourth unit that is configured to allow a movement about the third direction.

7. The system of claim 6, wherein the fourth unit comprises one of (a) an actuator integrated in a link and (b) at least one tangential linear motor.

8. The system of claim 1, wherein the first unit comprises a support fixed to one of said plates, the support being provided with a cylindrical internal recess of which the axis is parallel to the third direction and inside of which ball bushings are mounted coaxially, the other one of said plates being connected to one end of a solid cylinder that passes through the ball bushings.

9. The system of claim 1, wherein the second unit comprises a decoupling-blade assembly comprising an external annular structure that is fixed to one of said plates, the decoupling-blade assembly comprising a disc provided with a plurality of flexible blades, fixed centrally with respect to the other one of said plates.

10. A positioning device, comprising a system for relative movement between two plates that are substantially parallel to a plane defined by a first direction and a second direction perpendicular to the first direction, the system comprising:
a first unit configured to allow a relative movement between the two plates in a third direction, the third direction being orthogonal to the plane; and
a second unit configured to allow one plate to relatively travel with respect to the other plate about first and second directions,
wherein the first unit is configured to independently prevent a relative movement between the two plates in the plane.
